(19) United States
(12) Patent Application Publication
(10) Pub. No.: US 2017/0212415 A1
(43) Pub. Date: Jul. 27, 2017

(54) VARIABLE SCREEN SYSTEM

(71) Applicant: CJ CGV CO., LTD., Seoul (KR)

(72) Inventors: In Jae SEONG, Seoul (KR); No Chan PARK, Incheon (KR); Young Mi KIM, Seoul (KR); Bon Il KOO, Seoul (KR); Byoung Jun SONG, Incheon (KR); Min Jung KIM, Seoul (KR); Ok Sun KIM, Seoul (KR); Young Wook CHOI, Seoul (KR); Hae Jeong KOH, Seoul (KR)

(21) Appl. No.: 15/326,463

(22) PCT Filed: Jul. 15, 2015
(86) PCT No.: PCT/KR2015/007370

§ 371 Date: Jan. 13, 2017

(30) Foreign Application Priority Data
Jul. 15, 2014 (KR) 10-2014-0089365
Jul. 15, 2015 (KR) 10-2015-0100607

(51) Int. Cl. G03B 21/56; H04N 13/04; G03B 37/04; G03B 21/58; G03B 21/00; H04N 9/31

(52) U.S. Cl. CPC G03B 21/562; G03B 21/003; H04N 9/3147; H04N 9/3188; G03B 37/04; G03B 21/58; H04N 13/0459; H04N 13/0497; G03B 2206/00

(57) ABSTRACT

The present invention relates to a variable screen system for providing audience with more enhanced immersion by having a content image projected on a screen that is in the shape of a curved surface. More particularly, the present invention relates to a variable screen system comprising: a support for fixing a frame on which a screen is formed; and a theater server for controlling the support and thereby changing the curvatures of the frame or the screen formed on the frame.

### TECHNICAL FIELD

The present invention relates to a variable screen system for providing a higher sense of immersion to audiences by projecting a content image on a curved surface-shaped screen. More specifically, the present invention relates to a variable screen system, including a support that belongs to devices forming a variable screen system and that fixes a frame in which a screen has been formed and a theater server which changes the frame or curvature of the screen formed in the frame by controlling the support.

### BACKGROUND ART

In line with the recent diversification of movie content, a theater that is the space where the movie content can be watched is also greatly advanced. More specifically, many theaters consider various means in order to provide audiences with a higher three-dimensional (3-D) effect and a higher sense of immersion away from the frame of a screening environment in which a conventional 2-D image is projected.

Recently, active research is carried out on a 3-D imaging technology in order to provide an image having a 3-D effect. The 3-D imaging technology enables different images to enter the left and right eyes of an audience and enables the audience to have a three-dimensional effect in a process of the different images being recognized by the brain. In the 3-D imaging technology, two cameras on which different polarization filters have been mounted are used upon photographing and glasses on which polarization filters have been mounted are used when content is played back, so different images enter a left eye and a right eye.

However, such a 3-D technology can provide an audience with an image having a three-dimensional effect, but has a problem in that a degree of immersion into an image itself is low because an audience merely watches an image played back on a plane screen or a plane picture. Furthermore, there is a problem in that an audience must wear special glasses in order to watch a single piece of 3-D content in terms of audience convenience.

Accordingly, recently, there is an increasing demand for a screening environment for providing a sense of immersion and a three-dimensional effect to audiences in addition to 3-D technologies.

The present invention has been invented to solve the problems of such a conventional theater system and also has been invented to satisfy the aforementioned technological needs and to provide additional technological elements that may not be easily invented by those skilled in the art to which the present invention pertains.

### DISCLOSURE

### Technical Problem

The present invention relates to a variable screen system, including a screen, a support fixing the screen and a theater server. An object of the present invention is to implement a screening environment in which the theater server deforms the screen so that the screen has various forms (e.g., various forms of curvature) depending on a degree of the progress of content (a scene, a playback time, etc.) by controlling the support, thereby being capable of enhancing a degree of immersion into content by audiences.

More specifically, the present invention includes a support, including a horizontal stand having a length adjustable in a horizontal direction and a vertical stand having a length adjustable in a vertical direction, as an element. An object of the present invention is to allow a theater server to deform the shape of a screen by controlling the length of the horizontal stand or vertical stand of the support.

Furthermore, the present invention includes an assistant projector capable of projecting a content image on a projection surface within a theater, for example, the ceiling or the surface of a wall in addition to a screen. An object of the present invention is to allow audiences to be further immersed in content and to watch the content.

Furthermore, an object of the present invention is to enable audiences to watch an image without a sense of difference although the location or shape of a screen is deformed by controlling a projector so that the projection direction of the projector, the size of a projected content image or the degree of bending of the content image can be adjusted in accordance with the driving of a support, that is, a change in the location or shape of the screen.

Furthermore, an object of the present invention is to enable audiences to experience a proper additional effect in accordance with a change in the location or shape of a screen by controlling a plurality of effect devices provided within a theater in accordance with the driving of a support, that is, a change in the location or shape of the screen.

### Technical Solution

To solve the problems, a variable screen system according to the present invention includes a support receiving a support driving command and deforming a shape of a screen by driving a horizontal stand or a vertical stand in response to the support driving command.

Furthermore, the variable screen system further includes a theater server playing back content and sending a support driving command corresponding to the content to the support.

Furthermore, in this case, the variable screen system may further include a projector projecting a content image on the screen, and may further include an assistant projector projecting the content image on a projection surface within a theater other than the screen. In this case, the assistant projector projects a content image on a surface of a wall, a ceiling or a bottom surface within a theater.

A support according to another aspect of the present invention includes a reception unit which receives a support driving command, a vertical stand which is a support member having a vertical direction to a ground, a horizontal stand which is a support member having a horizontal direction to the ground, the horizontal stand having a length increased or decreased by a control unit, and the control unit which deforms a shape of a screen by controlling the length of the horizontal stand in response to the support driving command.

Furthermore, in the support, the vertical stand has a length increased or decreased by the control unit.

Furthermore, the tilt of the vertical stand or the horizontal stand is changed by an angle formed by the ground and the vertical stand or the horizontal stand and increased or decreased by the control unit.

Furthermore, in the support, one or more support driving commands correspond to a progress of content being played back. More specifically, in this case, the support driving command corresponds to the playback time, frame or scene of the content.

Furthermore, in the support, a plurality of the vertical stands or the horizontal stands is provided, and the control unit independently controls the lengths of the vertical stands or the horizontal stands. In this case, the control unit deforms the location and curvature of a screen by controlling the tilt of the vertical stand or the horizontal stand in response to the support driving command.

A theater server according to another aspect of the present invention includes a content playback unit which plays back content, a support control unit which receives or generates a support driving command corresponding to the content and sends the support driving command to a support, and a central control unit which controls the content playback unit and the support control unit.

Furthermore, in the theater server, one or more support driving commands correspond to a progress of content being played back.

Furthermore, in the theater server, the support driving command corresponds to the playback time, frame or scene of the content.

Meanwhile, the theater server further includes a projector control unit which controls a projector projecting a content image on a screen whose location or shape is changed in accordance with the driving of the support. In this case, the projector control unit adjusts the projection direction or size of the projected content image by controlling one or more projectors in accordance with the change in the location or shape of the screen.

Furthermore, the theater server may further include an effect device control unit which controls one or more effect devices within a theater in accordance with the driving of the support. In this case, the effect device control unit drives the effect devices in a direction in which the support is driven. More specifically, the effect device generates a sound, a wind, smell, fog, a temperature change, a laser, light, water spraying, vibration or soap bubbles.

### Advantageous Effects

In accordance with the present invention, there is an advantage in that a sense of immersion or a three-dimensional effect can be provided to an audience because a content image can be played back on a variable screen.

Furthermore, according to the present invention, there is an advantage in that senses of immersion and three-dimensional effects with various feelings can be provided to an audience because curvature in the horizontal axis or vertical axis of a screen can be freely changed by control of the theater server.

More specifically, according to the present invention, there is an advantage in that a high sense of immersion and a three-dimensional effect can be provided to an audience because the length of the path of light from a projector to a variable screen, preferably, a curved surface screen when a content image is projected on the screen is different.

Furthermore, according to the present invention, if a content image is reflected by a screen and reaches an audience, the path of light reflected by the screen can reach the audience through various paths by a variable screen, preferably, a curved surface screen. Accordingly, there is an advantage in that audiences can have a high sense of immersion and a three-dimensional effect.

Furthermore according to the present invention, curvature of a screen can be changed depending on a degree of the progress of content, for example, each scene or playback time. Accordingly, there are advantages in that from the viewpoint of a theater operator, an image in ideal curvature can be provided to each scene and an audience can watch content with a sense of immersion and a three-dimensional effect in each scene.

Furthermore, according to the present invention, there is an advantage in that a higher sense of immersion and a three-dimensional effect can be provided to an audience because a content image can be projected on a screen and a content image can also be projected on other projection surfaces, such as the surface of a wall and the ceiling within a theater.

### DESCRIPTION OF DRAWINGS

FIG. 1 schematically shows an overall configuration of a variable screen system according to the present invention.

FIG. 2 shows a support, a frame fixed to the support and a screen according to the present invention.

FIG. 3 shows the state in which the screen is deformed in various forms in accordance with the driving of the support, more specifically, an increase or decrease in the length of a horizontal stand.

FIG. 4 shows the state in which the screen is deformed in various forms in accordance with the driving of the support, more specifically, an increase or decrease in the length of a vertical stand.

FIG. 5 shows the state in which the screen is deformed in various forms in accordance with the driving of the support, more specifically, an increase or decrease in the tilt of the vertical stand and an increase or decrease in the length of the horizontal stand.

FIG. 6 shows the state in which the location of the screen rises in accordance with the driving of the support and comes into contact with the ceiling.

FIG. 7 shows the state in which a content image has been projected on the screen and other projection surfaces other than the screen.

FIG. 8 is a block diagram showing a detailed configuration of a theater server according to the present invention.

FIG. 9 shows the state in which a projector is controlled as the shape of the screen is changed.

FIG. 10 shows the state in which effect devices are controlled as the shape of the screen is changed.

FIGS. 11 and 12 show a process for changing the shape of the screen by driving the support in response to a degree of the progress of content.

### REFERENCE NUMERALS

| | |
|---|---|
| 100 support | 110 reception unit |
| 120 horizontal stand | 130 vertical stand |
| 140 control unit | 200 theater server |
| 210 content playback unit | 300 frame |
| 220 support control unit | 500 ceiling |
| 230 central control unit | 550 surface of wall |
| 600 seat | 700 projector |
| 800 effect device | S screen |

### MODE FOR INVENTION

The details of the objects and technological configurations of the present invention and acting effects thereof will be more clearly understood from the following detailed description based on the accompanying drawings. Hereinafter, embodiments of the present invention are described in detail with reference to the accompanying drawings.

Embodiments disclosed in this specification should not be interpreted as limiting or used to limit the range of right of the present invention. It is evident to those skilled in the art that a description including the embodiments of this specification has various applications. Accordingly, unless otherwise defined by the claims, some embodiments described are illustrative for better understanding, and the range of right of the present invention is not intended to be restricted by the embodiments.

Function blocks illustrated in the drawings and described hereunder are only examples of possible implementations. In other implementations, different functional blocks may be used without departing from the spirit and scope of the detailed description. Furthermore, one or more functional blocks of the present invention are illustrated as separate blocks, but one or more of the functional blocks of the present invention may be a combination of various hardware and software elements for executing the same function.

Furthermore, it should be understood that an expression that some elements are included is an expression of an open type and the expression simply denotes that the corresponding elements are present, but does not exclude additional elements.

Furthermore, when it is said that one element is connected (or coupled) to the other element, it should be understood that one element may be directly connected or coupled to the other element, but a third element may exist between the two elements.

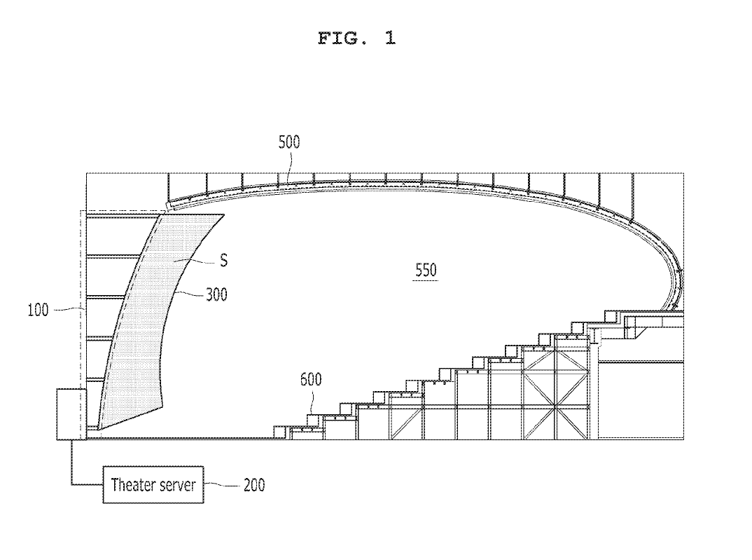

A comprehensive configuration of a variable screen system according to the present invention is described below with reference to FIG. 1.

Referring to FIG. 1, the variable screen system according to the present invention first includes a support 100.

It is based upon the premise that the support 100 refers to a structure basically including a horizontal stand 120 and a vertical stand 130 and the support fixes a frame 300 in which a screen S has been formed.

The frame 300 means a structure held in or fixed to the support 100. The frame 300 includes a horizontal member or vertical member having curvature and eventually functions to implement a variable screen S by closely attaching the screen to the members. As will be described later, the frame 300 may be deformed to have various types of curvature in accordance with an increase or decrease in the lengths of the horizontal stand 120 and vertical stand 130 provided in the support 100. Accordingly, the frame 300 may be preferably fabricated using an elastic material.

The screen S refers to a projection surface whose shape can be changed in various manners, and commonly refers to projection surfaces of various materials formed in the frame 300. Preferably, the screen S refers to a screen having curvature of a specific size in the horizontal axis or the vertical axis depending on curvature of the horizontal member or vertical member forming the frame 300. In this case, the materials of the screen S may include textiles, such as mat white, glass beads, ultra beads, a film, fiber glass and diamond, and various kinds in which textiles have been subjected to coating treatment. Furthermore, the screen S may be closely attached to the frame 300 using various methods. For example, various methods, such as a method for additionally attaching a magnetic member to the screen S and frame 300, a method for attaching intake means to the frame 300 so that the screen S is closely attached to the frame 300 and a method for coating an adhesive substance on the frame 300 so that the screen S is closely attached to the frame 300, may be taken into consideration as the method for closely attaching the screen S to the frame 300.

Meanwhile, the support 100 according to the present invention receives a support driving command from the outside and thus drives the horizontal stand 120 or the vertical stand 130 to change curvature of the variable screen S, more precisely, curvature of the frame 300, eventually changing curvature of the screen S.

The support driving command commonly refers to data including information necessary to drive the support 100, and may include the identifier number of the horizontal stand 120 or vertical stand 130 to be driven, a length to be increased or decreased, the tilt of the vertical stand 130 to be inclined, a driving start time and end time and so on.

Meanwhile, the support driving command is received from the outside. For example, the support driving command may be received using a method through an input device of a theater operator, a method through connection with a recording medium such as a USB or a method over a network from an external server.

Referring back to FIG. 1, the variable screen system, that is, the premise of the present invention, may further include a theater server 200.

The theater server 200 means a computer device for monitoring and controlling the entire theater. In the present invention, if the support 100 and the theater server 200 are present, the theater server 200 has a major function for playing back content and sending a support driving command, corresponding to the content, to the support 100.

As will be described later, the variable screen system according to the present invention changes curvature of the screen S depending on a degree of the progress of content. As described above, the theater server 200 functions to generate and send content played back and a support driving command corresponding to the generated content.

In addition to the support 100 and the theater server 200, an element forming the variable screen system may include other projection surfaces other than the screen, for example, a ceiling 500 and the surface 550 of a wall. The variable screen system may also include seats 600 in which audiences are seated.

According to the present invention, a content image may be played back in another area within a theater on which the content image can be projected in addition to the screen S. Referring to FIG. 1, the ceiling 500 may be used as a projection surface on which a content image may be played back. More specifically, if the location of the screen S is controlled so that the screen S comes into contact with the ceiling 500, the screen S and the ceiling 500 form a single huge projection surface, thus being capable of implementing a large-sized screen to the extent that audiences are overwhelmed.

The surface 550 of a wall within a theater may also be used as a projection surface on which a content image can be played back. Like the ceiling 500, the screen S may form a single huge projection surface along with the surfaces 550 of walls on the left and right sides of the screen S, thus being capable of implementing a large-sized screen.

If the screen S, the ceiling 500 and the surface 550 of a wall are used as projection surfaces, a content image implements a large-sized screen while surrounding the seats 600 in which audiences have been seated. Accordingly, there is an advantage in that audiences can watch an image with a higher sense of immersion and a three-dimensional effect.

Meanwhile, as may be seen from FIG. 1, it is preferred that the screen S and the ceiling 500 are implemented as ovalness when a theater is seen from the side. If a theater is implemented as ovalness as described above, there are advantages in that a degree of immersion and a degree of concentration for an image felt by an audience can be enhanced and a degree of concentration for a sound can also be enhanced because a sound output through a speaker is concentrated on an audience.

Finally, the variable screen system according to the present invention may also include the seats 600. It is based upon the premise that the seat 600 basically provides the space in which an audience can be seated. The seat 600 in the variable screen system may also function to assist an audience in having an optimum field of vision through a rotation motion or a tilting motion depending on a degree of the progress of content or a change in the curvature of the screen S. In this case, the driving of the seat 600 departs from the scope of the present invention, a detailed description thereof is omitted.

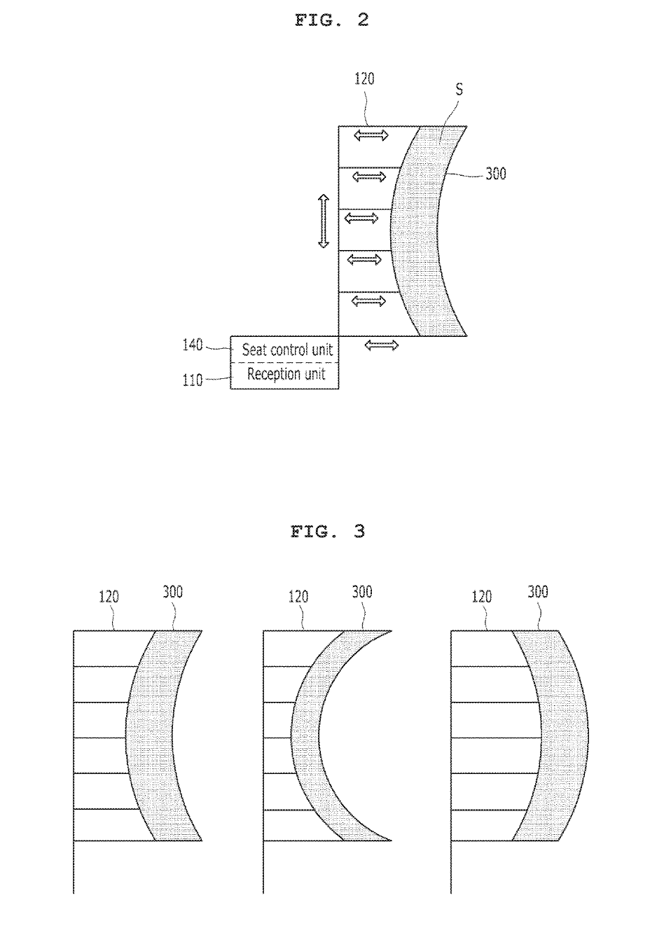

The support 100 according to the present invention is described in more detail below with reference to FIG. 2.

Referring to FIG. 2, the support 100 includes a reception unit 110, the vertical stand 130, the horizontal stand 120 and a control unit 140.

The reception unit 110 is a function unit which receives a support driving command from the outside. As described above, the support 100 may receive the support driving command from the outside in various manners. The reception unit 110 may be differently implemented depending on how the support driving command is received.

For example, the reception unit 110 may function to receive a support driving command when a theater operator directly inputs the support driving command to an input device. The reception unit 110 may be implemented using a connection unit to which a recording medium, such as a USB, can be connected, or may be implemented using communication means connected to a network, for receiving a support driving command over a wired network or a wireless network.

The horizontal stand 120 and the vertical stand 130 are members in or to which the frame 300 having the screen S formed therein is held or fixed. As may be seen from FIG. 2, a plurality of two or more horizontal stands 120 and vertical stands 130 may be present.

The lengths of the horizontal stand 120 and the vertical stand 130 in the horizontal direction or vertical direction may be increased or decreased. It is to be understood that all of various methods including a method using a hydraulic cylinder may be included in a method for adjusting the length of the horizontal stand 120 or the vertical stand 130.

Meanwhile, the tilt of the vertical stand 130 of the support 100 according to the present invention may also be adjusted in addition to the increase or decrease of the length of the vertical stand 130. That is, an angle formed by the vertical stand 130 and the surface 550 of a wall or an angle formed by the vertical stand 130 and the ground may be controlled by the control unit 140, so the vertical stand 130 may be inclined toward the direction of an audience or may be inclined in a direction distant from an audience.

In particular, a plurality of the horizontal stands 120 and the vertical stands 130 may be identified by respective unique identifiers. That is, a unique identifier may be assigned to each of the horizontal stands 120 or vertical stands 130 fixed to any specific location of the frame 300. The length of each horizontal stand 120 or vertical stand 130 to be increased or decreased is set so that the horizontal stands 120 or the vertical stands 130 may be individually controlled. If the plurality of horizontal stands 120 or vertical stands 130 is individually controlled as described above, there is an advantage in that a theater operator or a content producer can provide a more effective sense of immersion and a more effective three-dimensional effect to an audience because curvature of the screen S can be changed more minutely.

Furthermore, if the horizontal stands 120 or the vertical stands 130 are individually controlled as described above, there is an advantage in that the curved surface of ovalness (a curved surface including both curvature in the horizontal direction and curvature in the vertical direction) can be implemented because both curvature in the horizontal direction of the screen S and curvature in the vertical direction of the screen S can be generated. Meanwhile, it is evident that various forms in addition to the ovalness can be generated while the horizontal stands 120 or the vertical stands 130 are individually controlled.

Finally, the support 100 includes the control unit 140 for controlling the reception unit 110, the horizontal stand 120 and the vertical stand 130. In this case, the control unit 140 may include at least one operation device. The operation device may be a general-purpose central processing unit (CPU), a programmable device (CPLD, fPGA) implemented suitably for a specific purpose, an application-specific integrated circuit (ASIC) or a microcontroller chip.

FIG. 3 shows the state in which curvature of the screen S is deformed in various forms in accordance with an increase or decrease in the length of the horizontal stand 120 of the support 100.

FIGS. 3(a) to 3(c) show the horizontal stand 120 of the support 100, the frame 300 and the screen S seen from the side. On the basis of FIG. 3(a), the screen S may be deformed into shapes, such as those of FIGS. 3(b) and 3(c), depending on control of the length of the horizontal stand 120 of the support 100.

More specifically, assuming that identifiers #1 to #7 are randomly assigned to the plurality of horizontal stands 120 of FIG. 3 from the top, FIG. 3(b) shows the state in which curvature of the screen S has been deformed to have a great value by maintaining the length of the #4 horizontal stand 120, increasing the lengths of the #3 and #5 horizontal stands 120 by 0.5 m, increasing the lengths of the #2 and #6 horizontal stands 120 by 1 m, and increasing the lengths of the #1 and #7 horizontal stands 120 by 1.5 m. Meanwhile, in the detailed description, in order to help understanding of the invention, the control unit 140 has been illustrated as implementing required curvature by adjusting the length of the horizontal stands 120. It is however to be understood that an operation process for implementing curvature of the screen S may be various, such as that the control unit 140 first determines required curvature and calculates the length of a horizontal stand 120 to be increased or decreased based on the set curvature.

Meanwhile, FIG. 3(c) shows the state in which the screen S has been deformed in a convex form when viewed from a point of view of an audience. FIG. 3(c) shows the state in which curvature of the screen S has been deformed to have a negative value by maintaining the lengths of the #1 and #7 horizontal stands 120, decreasing the lengths of the #2 and #6 horizontal stands 120 by 0.5 m, decreasing the lengths of the #3 and #5 horizontal stands 120 by 1 m, and decreasing the length of the #4 horizontal stand 120 by 1.5 m.

Meanwhile, in the embodiment of FIG. 3, the screen S does not need to be essentially symmetrical up and down. It is to be understood that the screen S may be implemented to have a curved surface of an asymmetrical form depending on the degree of an increase or decrease in the length of each of the horizontal stands 120. In the aforementioned embodiments, the #1 and #7 horizontal stands 120 or the #2 and #6 horizontal stands 120 may be adjusted to have different lengths.

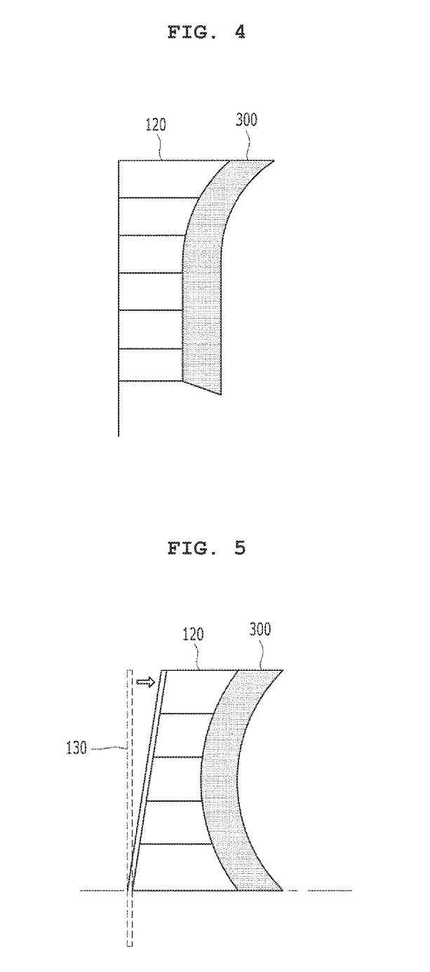

FIG. 4 shows a shape of the side of the support 100 and the screen S when the horizontal stands 120 are adjusted to have different lengths. For example, if the #1 to #4 horizontal stands 120 are adjusted to have lengths gradually reduced at an interval of 30 cm and the #5 to #7 horizontal stands 120 are adjusted to have the same length, the upper part of the screen S may be formed to have a curved line and the lower part of the screen S may be formed to have a straight line, as shown in FIG. 4.

FIG. 5 shows the state in which the tilt of the vertical stand 130 of the support 100 is controlled.

As described above, the support 100 according to the present invention may also control the tilt of the vertical stand 130. The tilt of the vertical stand 130 may be adjusted by setting the value of an angle formed by the surface 550 of a wall and the vertical stand 130 or the value of an angle formed by the ground and the vertical stand 130.

Meanwhile, when the tilt of the vertical stand 130 is changed, the tilt of the horizontal stand 120 connected to the vertical stand 130 may also be changed. The control unit 140 of the support 100 may adjust the tilt of the vertical stand 130 and at the same time, the tilt of the horizontal stand 120 so that the screen S is properly located in the direction of an audience.

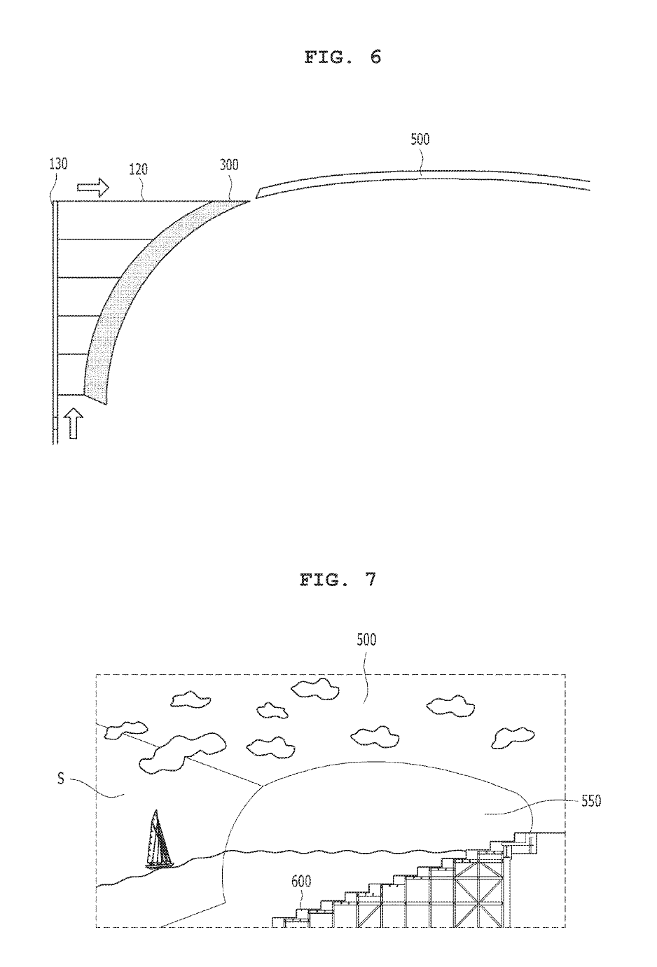

FIG. 6 shows the state in which the length of the vertical stand 130 of the support 100 is controlled.

The length of the vertical stand 130 may also be adjusted using the same method as the method for adjusting the length of the horizontal stand 120. More specifically, the screen S may be present at various locations of the front part of a theater by adjusting the height of the vertical stand 130 and the lengths of the horizontal stands 120 at the same time.

Referring to FIG. 6, if the length of the vertical stand 130 is increased in the state in which the horizontal stands 120 maintain the same shape as that of FIG. 4, the screen S may be located to come into contact with the ceiling 500 of a theater. More specifically, in this case, the screen S and the theater ceiling 500 can form ovalness and at the same time, the projection area of a content image can reach the ceiling 500 in addition to the screen S.

FIG. 7 shows the state in which a content image has been projected on a projection surface in the variable screen system according to the present invention. More specifically, FIG. 7 shows the state in which a single screen has been implemented in a large size up to the screen S, the ceiling 500 and the surface 550 of a wall if the screen S is located in the same shape as that of FIG. 6.

As described above with reference to FIGS. 2 to 6, the screen S according to the present invention may be deformed in various forms by controlling the horizontal stands 120 and vertical stand 130 of the support 100. In this case, various screening environments can be implemented in association with other projection surfaces of a theater.

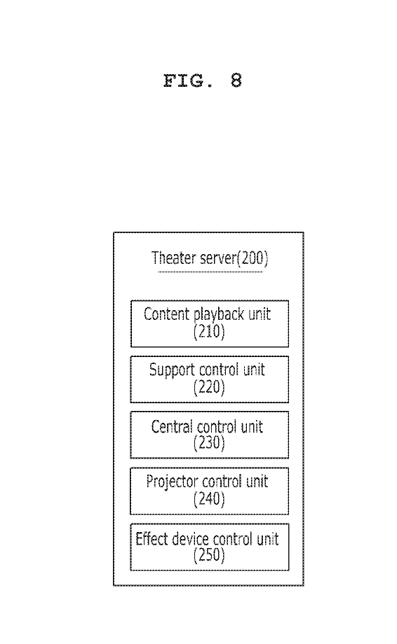

The theater server 200 forming the variable screen system according to the present invention is described below with reference to FIG. 8.

Referring to FIG. 8, the theater server 200 includes a content playback unit 210, a support control unit 220, a central control unit 230, a projector control unit 240 and an effect device control unit 250.

First, the content playback unit 210 is a function unit for playing back content within a theater including the variable screen S and preferably, plays back content received in a digital cinema package (DCP) form. In this case, the playback of the content means that one or more projectors or assistant projectors within a theater are controlled so that they project an image on a corresponding projection surface.

Next, the support control unit 220 functions to receive a support driving command from the outside or to receive or newly generate a support driving command and to send the support driving command to the support 100, as described above.

The support control unit 220 may be connected to the support 100 installed within a theater, more precisely, the reception unit 110 of the support 100 over a network, and may send a support driving command over the network.

Meanwhile, a plurality of the support driving commands received or generated by the support control unit 220 may be present with respect to a single content image, and may have been arranged in a series of order. Alternatively, a single support driving command may have included a driving command corresponding to the progress of a single content image.

Next, the central control unit 230 is a function unit for generally controlling the theater server 200. The central control unit 230 may be implemented using at least one operation device, for example, a general-purpose central processing unit (CPU), a programmable device (CPLD, fPGA) implemented suitably for a specific purpose, an application-specific integrated circuit (ASIC) or a microcontroller chip.

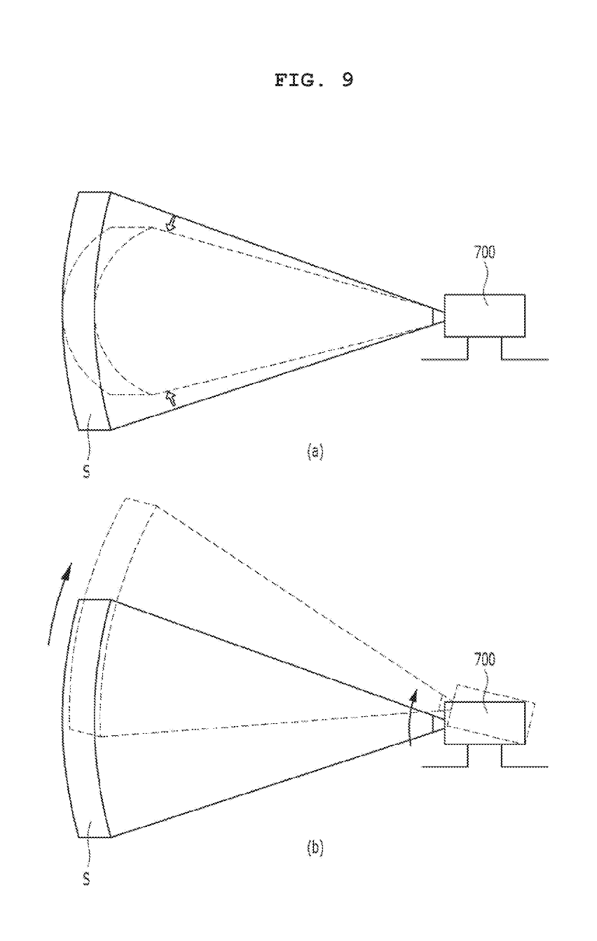

A method for controlling, by the theater server 200, a projector 700 is described below with reference to FIG. 9.

The theater server 200 may further include the projector control unit 240.

The projector 700 refers to a device for receiving a content image to be projected from the theater server 200 and directly projecting the received content image on the screen S. One or more projectors 700 may be disposed within the variable screen system in such a way as to face the screen S. Meanwhile, as described above, a projection surface on which a content image is projected may include the surface of a wall and the ceiling in addition to the screen S. It is to be understood that a plurality of the projectors 700 may be disposed to face respective projection surfaces.

Meanwhile, according to the present invention, since the shape of the screen S may continue to be deformed, the projector 700 that projects an image on the screen S having a varying shape also needs to project an image in accordance with a shape of the screen S.

As described above, in order to project an image suitable for the screen S having a varying shape, the projector control unit 240 functions to adjust i) the direction in which the projector 700 projects an image, ii) the size of an image projected by the projector 700, and iii) the distortion degree of an image (a degree of bending of an image).

In relation to i), one or more projectors 700 disposed within a theater may be basically moved on the basis of an axis capable of front and back/up and down/left and right/rotation motions because the projection direction of the projectors 700 has to be changed in accordance with a change in the shape and/or location of the screen. For example, if the location of the screen S rises to the extent that the screen S may come into contact with the ceiling in accordance with the driving of the support, the projector control unit 240 may move upward the projection direction of an image by controlling the driving shaft of the projector 700.

In relation to ii), one or more projectors 700 disposed within a theater may adjust the size of an image projected in accordance with a change in the shape of the screen. For example, assuming that an orthogonal projection is formed on a virtual plane at the back of the screen S, if curvature of the screen S is increased, the area of the orthogonal projection is reduced. At this time, the projector 700 may project an image having a reduced size so that the image is properly viewed in accordance with the standard of the reduced area of the screen S. Meanwhile, the projector 700 may adjust the size of a content image by directly performing a correction process on the content image, the size of a content image may be adjusted by moving the location of the projector 700 back and forth, or the size of a content image may be adjusted by adjusting the lens focus of the projector 700.

In relation to iii), one or more projectors 700 disposed within a theater may also adjust the degree of bending of a projected image in accordance with a change in the shape of the screen. In this case, it is understood that the degree of bending of an image refers to a degree to which on the assumption of a rectangular standard image, the corresponding image has been distorted due to curvature generated in upper and lower sides and left and right sides. For example, if curvature of the screen S is changed in accordance with the driving of the support, the projector 700 may project an image so that the projected image is distorted in accordance with the deformed curvature of the screen S. At this time, the projector 700 may perform the degree of bending of the content image by directly performing a correction process on the content image. The content image may have been properly distorted and edited according to the degree of progress of the content image in response to a producer's intention when the content image is first received by the theater server 200.

Meanwhile, in addition to the aforementioned examples of i) to iii), the projector control unit 240 may have a content image clearly focused on the screen in accordance with a change in the shape of the screen or a change in the location of the projector 700 by controlling the projector 700. More specifically, the projector control unit 240 may control the projector 700 so that a content image is focused on the screen through zoom-in/zoom-out.

FIGS. 9(a) and 9(b) show the state in which the projector 700 is controlled so that a proper content image is projected in accordance with a change in the shape or location of the screen S.

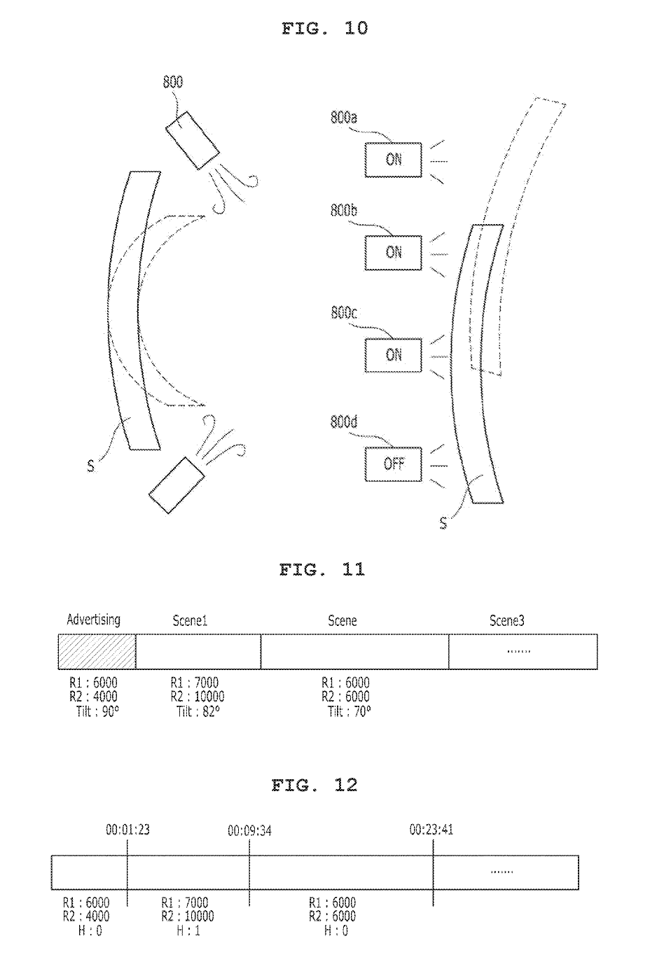

A method for controlling, by the theater server 200, effect devices 800 included in a theater in accordance with a change in the shape or location of the screen S is described below with reference to FIG. 10.

The theater server 200 according to the present invention may further include the effect device control unit 250.

The effect devices 800 are devices for further generating physical effects in addition to the provision of an image in order to provide a higher sense of immersion to audiences within a theater, and include devices for generating a sound, the wind, smell, fog, a temperature change, a laser, light, water spraying, vibration and soap bubbles.

The effect device control unit 250 of the theater server 200 controls one or more effect devices 800. More specifically, the effect devices 800 may be controlled in accordance with a change in the shape of the screen S.

For example, if curvature of the screen S is suddenly increased by the driving of the support, the width of ends on the left and right sides of the screen S is narrowed in the direction of seats in which audiences have been seated. At this time, the audiences can feel the wind simultaneously with an increase of the curvature of the screen S by driving fans provided on the left and right sides of the screen S, thereby being capable of providing a screening environment including the feeling of movement. That is, in the case of an embodiment on the left side of FIG. 10, when the screen S is concavely deformed (indicated by a dotted line) in the direction of seats, the effect device control unit 250 sends air by controlling the effect devices (fans) 800 on the left and right sides of the screen S, so audiences can experience an additional effect simultaneously with the deformation of the screen S.

For another example, if the screen S suddenly rises by the driving of the support, sound effect devices 800 disposed at specific heights, that is, speakers, may be sequentially driven from bottom to top, so audiences can feel a sound rise effect simultaneously with the rise of the screen. For example, in the case of an embodiment on the right side of FIG. 10, if the screen S rises compared to an existing location (indicated by a dotted line) in accordance with the driving of the support, the effect device control unit 250 may turn off a speaker 800d that belongs to effect devices, that is, a plurality of speakers (800a, 800b, 800c and 800d) and that is located at the bottom and turns on a speaker 800a at the top, so audiences can also aurally experience an effect according to a change in the location of the screen.

As described above, the variable screen system according to the present invention may include the plurality of effect devices 800. The theater server 200 includes the effect device control unit 250 capable of controlling the effect devices 800, so the effect devices 800 can operate in accordance with a change in the shape of the screen S.

Meanwhile, the support 100 according to the present invention is controlled by a support driving command. In this case, the support driving command is generated in accordance with a degree of the progress of content as described above.

FIGS. 11 and 12 show that a command for controlling the support 100 has been generated for each scene or for each playback time as one piece of content is played back.

Referring to FIG. 11, the support driving command may include commands divided into respective scenes. Assuming that R1 and R2 are horizontal-direction curvature and vertical-direction curvature of the screen S, respectively, and a tilt is an angle formed by the vertical stand 130 and the ground, a support driving command may be configured based on scenes, such as that R1 becomes 6000, R2 becomes 4000 and the tilt becomes 90 degrees when advertising is played back prior to the playback of a content image, R1 becomes 7000, R2 becomes 10000 and the tilt becomes 82 degrees when a scene 1 of a content image is played back, and R1 and R2 become 6000 and the tilt becomes 70 degrees when a scene 2 is played back.

Referring to FIG. 12, a support driving command in the present invention may be configured based on the playback time of a content image as in FIG. 11. Assuming that R1 and R2 are horizontal-direction curvature and vertical-direction curvature of the screen S, respectively, and H is the height of the vertical stand 130, a support driving command may be configured based on the playback time of a content image, such as that R1 becomes 6000, R2 becomes 4000 and the height of the vertical stand 130 becomes 0 at a point of time at which the content image is first started, R1 becomes 7000, R2 becomes 10000 and the height of the vertical stand 130 becomes 1 from a point of time of 1 minute 23 seconds of the content image to a point of time of 9 minutes 34 seconds, and R1 and R2 become 6000 and the height of the vertical stand 130 becomes 0 up to a point of time of 23 minutes 41 seconds.

Although some embodiments and application examples of the present invention have been illustrated and described above, the present invention is not limited to the aforementioned specific embodiments and application examples and may be deformed in various ways by those skilled in the art to which the present invention pertains without departing from the gist of the present invention written in the claims. Such deformed embodiments should not be construed as being distinct from the technological spirit or prospect of the present invention.

1. A variable screen system, comprising:
a support receiving a support driving command and deforming a shape of a screen by driving a horizontal stand or a vertical stand in response to the support driving command.

2. The variable screen system of claim 1, further comprising a theater server playing back content and sending a support driving command corresponding to the content to the support.

3. The variable screen system of claim 2, further comprising a projector projecting a content image on the screen.

4. The variable screen system of claim 3, further comprising an assistant projector projecting the content image on a projection surface within a theater other than the screen.

5. The variable screen system of claim 4, wherein the assistant projector projects a content image on a surface of a wall, a ceiling or a bottom surface within a theater.

6. A support, comprising:
a reception unit which receives a support driving command;
a vertical stand which is a support member having a vertical direction to a ground;
a horizontal stand which is a support member having a horizontal direction to the ground, the horizontal stand having a length increased or decreased by a control unit; and
the control unit which deforms a shape of a screen by controlling the length of the horizontal stand in response to the support driving command.

7. The support of claim 6, wherein the vertical stand has a length increased or decreased by the control unit.

8. The support of claim 6, wherein a tilt of the vertical stand or the horizontal stand is changed by an angle formed by the ground and the vertical stand or the horizontal stand and increased or decreased by the control unit.

9. The support of claim 6, wherein one or more support driving commands correspond to a progress of content being played back.

10. The support of claim 9, wherein the support driving command corresponds to a playback time, frame or scene of the content.

11. The support of claim 6, wherein:
a plurality of the vertical stands or the horizontal stands is provided, and
the control unit independently controls the lengths of the vertical stands or the horizontal stands.

12. The support of claim 11, wherein the control unit deforms a location and curvature of a screen by controlling a tilt of the vertical stand or the horizontal stand in response to the support driving command.

13. A theater server, comprising:
a content playback unit which plays back content;
a support control unit which receives or generates a support driving command corresponding to the content and sends the support driving command to a support; and
a central control unit which controls the content playback unit and the support control unit.

14. The theater server of claim 13, wherein one or more support driving commands correspond to a progress of content being played back.

15. The theater server of claim 14, wherein the support driving command corresponds to a playback time, frame or scene of the content.

16. The theater server of claim 13, further comprising a projector control unit which controls a projector projecting a content image on a screen whose location or shape is changed in accordance with a driving of the support.

17. The theater server of claim 16, wherein the projector control unit adjusts a projection direction or size of the projected content image by controlling one or more projectors in accordance with the change in the location or shape of the screen.

18. The theater server of claim 13, further comprising an effect device control unit which controls one or more effect devices within a theater in accordance with a driving of the support.

19. The theater server of claim 18, wherein the effect device control unit drives the effect devices in a direction in which the support is driven.

20. The theater server of claim 19, wherein the effect device generates a sound, a wind, smell, fog, a temperature change, a laser, light, water spraying, vibration or soap bubbles.
